(19) United States
(12) Patent Application Publication
(10) Pub. No.: US 2009/0085425 A1
(43) Pub. Date: Apr. 2, 2009

(54) Flat Spring and Voice Coil Motor using the same

(76) Inventor: Wen-Chia Chang, Hsin-Chu (TW)

Correspondence Address: HDLS Patent & Trademark Services, P.O. BOX 220746, CHANTILLY, VA, 20153-0746, US

(21) Appl. No.: 11/937,309

(22) Filed: Nov. 8, 2007

(30) Foreign Application Priority Data
Sep. 27, 2007 (TW) 096136032

(51) Int. Cl. H02K 33/02

(52) U.S. Cl. 310/273

(57) ABSTRACT

A flat spring of a voice coil motor includes a fixing frame having a first connector, and an elastic arm. The elastic arm includes a main body, and a first curve portion. The first curve portion is arranged on one terminal end of the main body and connects with the first connector of the fixing frame, or is arranged on one terminal end of the main body, which extends to the fixing frame.

### FIELD OF THE INVENTION

The present invention relates to a flat spring of a voice coil motor, and a voice coil motor using the same.

### DESCRIPTION OF THE RELATED ART

Voice coil motors have many advantages, such as small bulk, low power, accurate actuating displacement, and low cost, etc. The voice coil motors are suited as short-distance actuators of electronic devices, such as motors of mobiles, optical actuators of head, and auto-focusing devices of cameras, etc. However, the voice coil motors have a slower actuating/regressing speed than that of the electronic devices, therefore, the voice coil motors need at least one spring to accelerate the actuating/regressing speed.

Referring to FIG. 1, a conventional voice coil motor used in an auto-zoom camera is shown. The voice coil motor includes a cover 100, a base 105, an outer frame 110, a lens supporting 120 and two flat springs 130. The two flat springs 130 are fixed on two terminal ends of the outer frame 110 respectively to be configured for limiting the lens supporting in the outer frame 110. Magnet 115 is arranged around the periphery of the outer frame 110. The lens supporting 120 has a winding 125 fixed thereon. When the winding 125 is supplied different direction currents, the winding 125 produces a magnetic field, which attracts or repulses that produced by the magnet 115, such that the lens supporting 120 moves upwards or downwards.

Referring to FIG. 2, one of the two flat springs 130 is shown. Each of the two flat springs 130 includes a fixing frame 131, four elastic arms 132 and a moving frame 133. The two fixing frames 131 of the two flat springs 130 are fixed on two terminal ends of the outer frame 110 respectively. The two moving frame 133 thereof are fixed on two terminal ends of the lens frame 120. The elastic arms 132 are connected between the fixing frame 131 and the moving frame 133. The fixing frame 131, the four elastic arms 132 and the moving frame 133 are integrated together, and arranged on a planar plane.

When the elastic arms 132 produce an elastic deformation, a joint between the elastic arms 132 and the fixing frame 131 receives a maximal stress. If the lens supporting 120 produces a larger displacement, the joint will produce an extremely difficult stress such that the elastic arms 132 will lose the elasticity. Therefore, the flat spring has a bad flexibility, and it should be solved.

What is needed, are a flat spring and a voice coil motor using the same, which can solve the above problems.

### BRIEF SUMMARY

An object of the present invention is providing a flat spring having an excellent flexibility.

Another object of present invention is providing a voice coil motor using the above flat spring.

A flat spring of a voice coil motor, in accordance with a preferred embodiment of the present invention, includes a fixing frame having a first connector, and an elastic arm. The elastic arm includes a main body, and a first curve portion. The first curve portion is arranged on one terminal end of the main body and connects with the first connector of the fixing frame, or is arranged on one terminal end of the main body, which extends to the fixing frame.

The elastic arm further includes a second curve portion arranged on another terminal end of the elastic arm opposite to the first curve portion. The first curve portion is arranged on one terminal end of the elastic arm and connects with the first connector of the fixing frame. The second curve portion is arranged on another terminal end of the elastic arm, which extends to the fixing frame.

A voice coil motor, in accordance with another preferred embodiment of the present invention, includes an outer frame having a first connecting base, a moving element arranged in the outer frame, and at least one flat spring. The moving element is moveable relating to the outer frame and in the outer frame, and the moving element includes a second connecting base. Each flat spring includes a fixing frame having a first connector, and at least one elastic arm. Each elastic arm includes a main body, and a first curve portion. The first curve portion is arranged on one terminal end of the main body and connects with the first connector of the fixing frame to connect with the first connecting base of the outer frame through the first connector, or is arranged on one terminal end of the main body, which extends to the fixing frame, to connect with the second connecting base.

The elastic arm further includes a second curve portion and a second connector. The second curve portion is arranged on another terminal end of the main body opposite to the first curve portion. The first curve portion is arranged on the one terminal end of the main body and connects with the first connector to connect with the first connecting base of the outer frame through the first connector. The second curve portion is arranged on another terminal end of the main body, which extends to the fixing frame to connect with the second connecting base.

Compared with the conventional arts, the each elastic arm of the flat spring has the curve portions arranged on the two terminal ends thereof respectively. The curve portions are configured for connecting with the fixing frame and the moving element. The curve portions can receive parts of the stress produced by the elastic deformation of the elastic arm, such that the elastic arm can receives more stress. Therefore, the flat spring has an excellent flexibility.

Other objects, advantages and novel features of the invention will become more apparent from the following detailed description when taken in conjunction with the accompanying drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, exploded view of a voice coil motor of a camera of a conventional art;

FIG. 2 is a schematic, plane view of a flat spring in FIG. 1;

FIG. 3 is a schematic, exploded view of a voice coil motor in accordance with a first preferred embodiment of the present invention;

FIG. 4 is a schematic, plane view of a flat spring in FIG. 3;

FIG. 5 is a schematic, plane view of a flat spring in accordance with a second preferred embodiment of the present invention;

FIG. 6 is a schematic, plane view of a flat spring in accordance with a third preferred embodiment of the present invention; and

FIG. 7 is a schematic, plane view of a flat spring in accordance with a fourth preferred embodiment of the present invention.

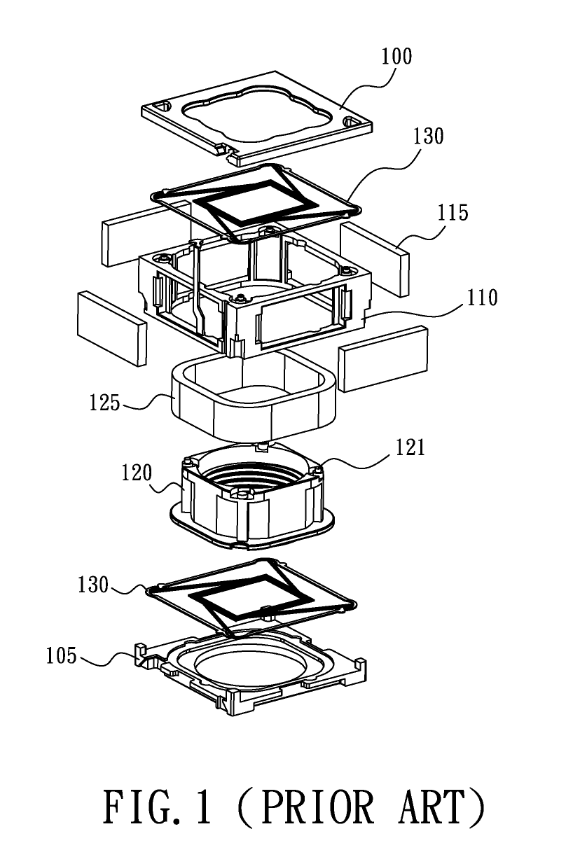

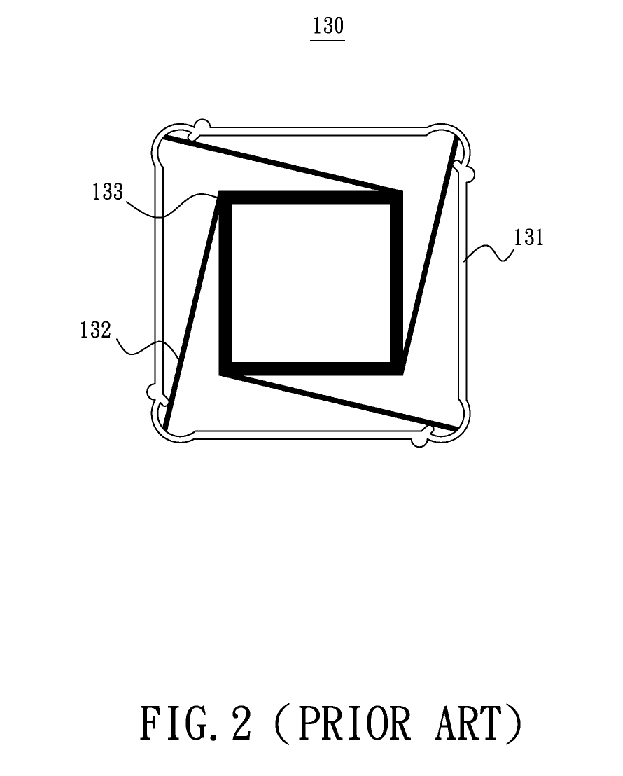

### DETAILED DESCRIPTION

Reference will now be made to the drawings to describe a preferred embodiment of the present touch pen and portable wireless communication device, in detail.

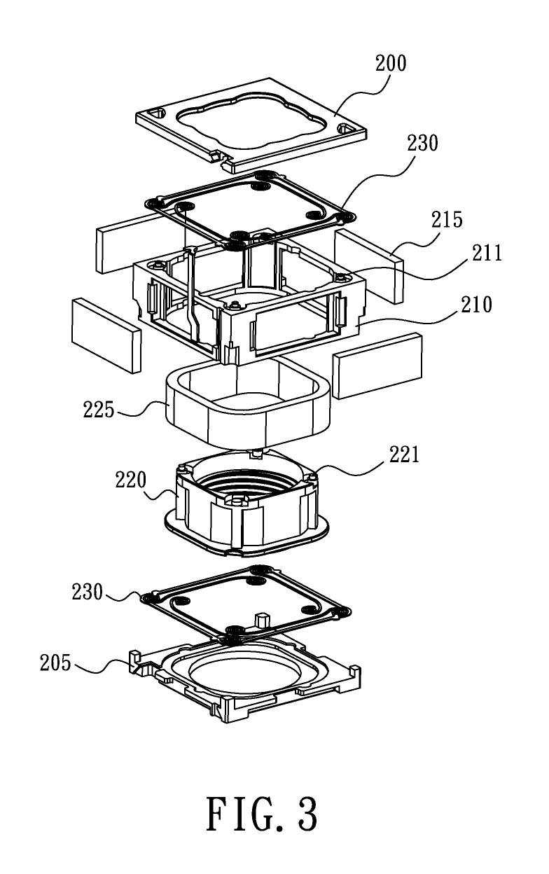

Referring to FIG. 3, a voice coil motor in accordance with a first preferred embodiment of the present invention is shown. The voice coil motor includes a cover 200, a substrate 205, an outer frame 210, a moving element 220, and two flat springs 230. The two flat springs 230 are fixed on two terminal ends of the outer frame 210 respectively, to be configured for limiting the moving element 220 in the outer frame 210. Four first connectors 210 are arranged on four corners of a surface of the outer frame 210 respectively. Four second connectors 221 are arranged on four corners of a surface of the moving element 220 respectively. The first connecting base 211 and the second connecting base 221 may respectively be a column or a screw (not shown). The moving element 220 may be a lens of a camera, a lens supporting of a camera, or head, etc. A magnet 215 is arranged around the periphery of the outer frame 210. The moving element 220 has a winding 225 fixed thereon. When the winding 225 is supplied different direction currents, the winding 225 produces a magnetic field, which attracts or repulses a magnetic field produced by the magnet 215, such that the moving element 220 relating to the outer frame 210 moves upwards or downwards in the outer frame 210.

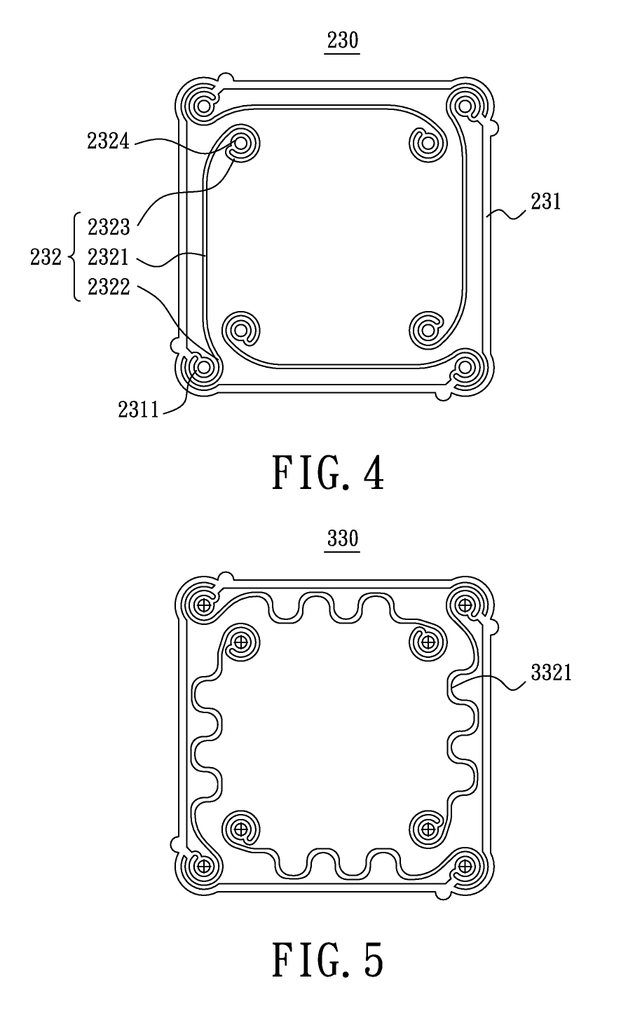

Referring to FIG. 4, one of the two flat springs 230 is shown. Each of the two flat springs 230 includes a quadrate fixing frame 231 and four elastic arms 232. The quadrate fixing frame 231 and the four elastic arms 232 are arranged approximately on a plane. Four first connectors 2311 are arranged on four corners of the fixing frame 231. The four first connectors 2311 may be a circular hole, a bolt or a screw (not shown). Each of the elastic arms 232 includes a main body 2321 and a first curve portion 2322 and a second curve portion 2323. The first curve portion 2322 and the second curve portion 2323 are arranged on two terminal ends of the main body 2321. The main body 2321 is linear and smoothly connects with the first curve portion 2322 and the second curve portion 2323. The main body 2321, the first curve portion 2322 and the second curve portion 2323 are integrated together. The first curve portion 2322 has a bending direction opposite to that of the second curve portion 2323. Each of the second curve portions 2323 connects with a second connector 2324. The second connector 2324 may be a circular hole, a bolt, or a screw (not shown). The first curve portion 2322 of each elastic arm 232 connects correspondingly with one of the first connectors 2311 of the fixing frame 231. Each first connector 2311 is fixed on the one of the first connecting base 211 of the outer frame 210. Each second connector 2324 is fixed correspondingly on the one of the second connecting base 221 of the moving element 220. The above connecting mode may be cooperated by the bolt and the screw or glued.

When the moving element 220 moves relating to the outer frame 210, the second curve portions 2323 of the flat springs 230 moves together, such that the elastic arms 232 produce elastic deformations. Since the second curve portions 2323 of the elastic arms 232 have a bending shape, parts of the stress produced in the joint, which is between the second curve portions 2323 and the main body 2321, will be received by the curve portions. Therefore, the flat springs will receive more stress, and have an excellent flexibility. When the winding 225 is not supplied the current, the force of the moving element 220 produced by the magnet 215 disappears, and the moving element 220 returns to the original location by the elastic arms 232.

Compared with the conventional arts, each elastic arm 232 of the flat spring 230 of the present invention has two curve portions arranged on the two terminal ends thereof respectively. The curve portions are configured for connecting with the fixing frame 231 and the moving element 220. The curve portions can receive parts of the stress produced by the elastic deformation of the elastic arms 232, such that the elastic arms 232 can receive more stress. Therefore, the flat springs 230 have an excellent flexibility. The first curve portion 2322 may be bent same or opposite to the second portion 2323, which can obtain same results.

Furthermore, each elastic arm 232 of the flat spring 230 may includes a curve portion, which is arranged on one of the terminal ends of the each elastic arm 232. The curve portion may be arranged on one terminal end of the main body 2321, and connect with the first connector 2311 of the fixing frame 231, thus the curve portion connects with the first connecting base 211 of the outer frame 210 through the first connector 2311. Furthermore, the curve portion is arranged on one terminal end of the main body 2321, which extends to the fixing frame 231, and connects with the second connecting base 2324.

Referring to FIG. 5, a flat spring 330 in accordance with a second preferred embodiment of the present invention is shown. The flat spring 330 is similar to the flat spring 230 of the first preferred embodiment, except that the main body 3321 of the flat spring 330 is a regular curve waved shape.

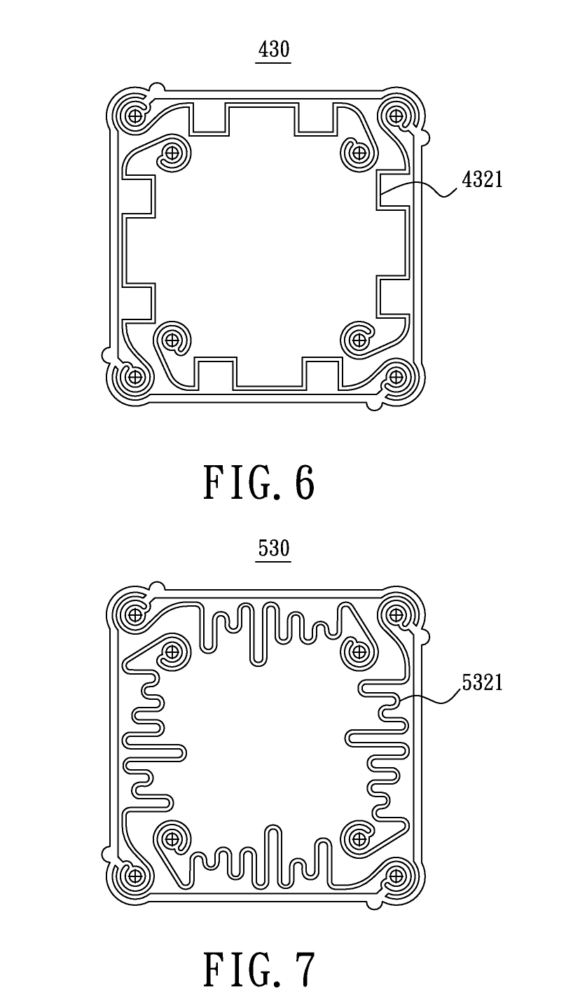

Referring to FIG. 6, a flat spring 430 in accordance with a third preferred embodiment of the present invention is shown. The flat spring 430 is similar to the flat spring 230 of the first preferred embodiment, except that the main body 4321 of the flat spring 430 is a regular square waved shape.

Referring to FIG. 7, a flat spring 530 in accordance with a fourth preferred embodiment of the present invention is shown. The flat spring 530 is similar to the flat spring 230 of the first preferred embodiment, except that the main body 5321 of the flat spring 530 is an irregular waved shape.

The present invention may include other preferred embodiments. For example, the fixing frame may be circular, rectangular, and so on. The present invention may include one or at least one elastic arm instead of four elastic arms, to produce enough elastic force when the moving element moves relating to the outer frame 210.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A flat spring of a voice coil motor, comprising:
a fixing frame having a first connector; and
an elastic arm, the elastic arm comprising:
a main body; and
a first curve portion arranged on one terminal end of the main body and connecting with the first connector of the fixing frame, or arranged on one terminal end of the main body, which extends to the fixing frame.

2. The flat spring as claimed in claim 1, wherein the elastic arm further comprises a second curve portion arranged on another terminal end of the elastic arm opposite to the first curve portion, wherein the first curve portion is arranged on one terminal end of the elastic arm and connects with the first connector of the fixing frame, and the second curve portion is arranged on another terminal end of the elastic arm, which extends to the fixing frame.

3. The flat spring as claimed in claim 1, wherein the elastic arm and the first curve portion are integrated together.

4. The flat spring as claimed in claim 2, wherein the elastic arm, the first curve portion and the second curve portion are integrated together.

5. The flat spring as claimed in claim 2, wherein the first curve portion is bent opposite to the second curve portion.

6. The flat spring as claimed in claim 1, wherein the first connector of the fixing frame is selected from a group consisting of a circular hole, a bolt and a screw.

7. The flat spring as claimed in claim 2, wherein the second curve portion connects to a second connector.

8. The flat spring as claimed in claim 7, wherein the second connector is selected from a group consisting of a circular hole, a bolt and a screw.

9. The flat spring as claimed in claim 1, wherein the main body has a shape selected from a group consisting of a linear shape, a regular curve waved shape, a regular square waved shape, and an irregular waved shape.

10. A voice coil motor, comprising
an outer frame having a first connecting base;
a moving element arranged in the outer frame, the moving element being moveable relating to the outer frame and in the outer frame, the moving element including a second connecting base; and
a flat spring, the flat spring comprising:
a fixing frame having a first connector; and
an elastic arm, the elastic arm comprising:
a main body; and
a first curve portion arranged on one terminal end of the main body and connecting with the first connector of the fixing frame to connect with the first connecting base of the outer frame through the first connector, or arranged on one terminal end of the main body, which extends to the fixing frame to connect with the second connecting base.

11. The voice coil motor as claimed in claim 10, wherein the elastic arm further comprises a second curve portion arranged on another terminal end of the main body opposite to the first curve portion, wherein the first curve portion is arranged on the one terminal end of the main body and connects with the first connector to connect with the first connecting base of the outer frame through the first connector, the second curve portion is arranged on the another terminal end of the main body, which extends to the fixing frame to connect with the second connecting base.

12. The voice coil motor as claimed in claim 11, wherein the elastic arm further comprises a second connector, and the second curve portion connects with the second connector to connect with the second connecting base of the moving element through the second connector.

13. The voice coil motor as claimed in claim 11, wherein the main body and the first curve portion are integrated together or the main body and the first curve portion and the second curve portion are integrated together.

14. The voice coil motor as claimed in claim 10, wherein the first connecting base of the outer frame and the second connecting base of the moving element are respectively selected from a group consisting of a column and a screw.

15. The voice coil motor as claimed in claim 10, wherein the first connecting base of the outer frame and the first connector are connected through a mode selected form a group consisting of cooperating by the bolt and the screw, and gluing.

16. The voice coil motor as claimed in claim 12, wherein the second connecting base of the moving element and the second connector are connected through a mode selected form a group consisting of cooperating by the bolt and the screw, and gluing.

17. The voice coil motor as claimed in claim 11, wherein the first curve portion is bent opposite to the second curve portion.

18. The voice coil motor as claimed in claim 12, wherein the first connector and the second connector are respectively selected from a group consisting of a circular hole, a bolt and a screw.

19. The voice coil motor as claimed in claim 10, wherein the main body has a shape selected from a group consisting of a linear shape, regular curve waved shape, regular square waved shape, and a irregular waved shape.

20. The voice coil motor as claimed in claim 10, wherein the moving element is selected from a group consisting of a lens of a camera, a lens supporting of a camera, and a head.
